(19) United States
(12) Patent Application Publication
(10) Pub. No.: US 2008/0070626 A1
(43) Pub. Date: Mar. 20, 2008

(54) System for Remote-Controlling Broadcast Apparatus Using a Pda

(76) Inventor: Young-Woo Song, Daegu (KR)

Correspondence Address: IPLA P.A., 3580 WILSHIRE BLVD., 17TH FLOOR, LOS ANGELES, CA, 90010, US

(21) Appl. No.: 11/577,863

(22) PCT Filed: Jan. 20, 2005
(86) PCT No.: PCT/KR05/00187

§ 371 Date: Apr. 24, 2007

(30) Foreign Application Priority Data
Nov. 8, 2004 (KR) 10-2004-0090347

(51) Int. Cl. H04M 1/00

(52) U.S. Cl. 455/556.2

(57) ABSTRACT

Provided is a system for remotely controlling a broadcasting system not only in a broadcasting room but also outside the broadcasting room. A program of controlling the broadcasting system is installed in a PDA. Signals input to the PDA by a user are transmitted using Bluetooth (or wireless LAN, infrared port or the like) that is a transmission medium. A signal converter of a 232C (or 1394, USB or the like) distributor receives the transmitted signals. A microprocessor transmits the signals output from the signal converter to controllers to control the broadcasting system. Accordingly, broadcasting apparatuses can be remotely controlled outside the broadcasting room.

### TECHNICAL FIELD

The present invention relates to a method and system for wirelessly controlling a broadcasting system or various electronic apparatuses of a broadcasting room indoors or outdoors.

### BACKGROUND ART

In a conventional broadcasting system disclosed in Korean Patent No. 418695, a video mixer, an audio mixer and a mechanical A/V apparatus are integrated and a program of controlling the integrated apparatus is installed in a computer. Thus, a user easily operates the broadcasting system in a graphic user interface (GUI) environment of the computer.

Referring to FIG. 1, the conventional broadcasting system includes an electronic controller that integrates the video mixer, audio mixer and mechanical A/V apparatus, the computer 100 in which the program of controlling the electronic controller is installed, control panels 10 and 20 for manually operating the broadcasting system when the computer 100 cannot control the broadcasting system, and a 232C (or 1397, USB or the like) distributor 200 for connecting serial ports of the computer 100 to a fantilt controller, a video controller, a speaker controller, a power controller and the electronic controller. Specifically, the fantilt controller for controlling fantilt of a camera, the video controller for controlling an A/V apparatus, a speaker controller for controlling a speaker, and the power controller for controlling lighting of a broadcasting room or system power are connected to the 232C (or 1394, USB or the like) distributor 200.

In the conventional broadcasting system, a user inputs a signal to the computer in which the program is installed using a mouse or a touch screen to control the broadcasting system through the input signal. Thus, the broadcasting system is controlled only in the broadcasting room. That is, the broadcasting system of the broadcasting room is controlled only in a restricted area.

### DISCLOSURE OF INVENTION

### Technical Problem

Accordingly, the present invention has been made to solve the above problems occurring in the prior art, and it is an object of the present invention to provide a method and system for controlling a broadcasting system of a broadcasting room not only inside the broadcasting room or a control room but also outside the broadcasting room or the control room. The system for controlling a broadcasting system includes a personal digital assistant (PDA) in which a program for controlling the broadcasting system is installed, a transmitter for transmitting a control signal of the PDA, and a 232C (or 1394, USB or the like) distributor for receiving and converting the control signal transmitted from the transmitter, thereby wirelessly controlling the broadcasting system.

### Technical Solution

To accomplish the object of the present invention, a program for controlling a broadcasting system or other control systems is installed in a PDA, and the PDA transmits a signal input by a user using a wireless transmitter such as a wireless LAN (or infrared port, Bluetooth or the like) that is a wireless transmission medium. A signal converter of a 232C (or 1394, USB or the like) distributor receives the signal transmitted from the PDA and a microprocessor transmits the signal output from the signal converter to a controller requiring to be controlled to control the broadcasting system or other control systems.

### Advantageous Effects

According to the present invention, broadcasting apparatuses can be controlled even outside a broadcasting room or a control room.

### BRIEF DESCRIPTION OF THE DRAWINGS

Further objects and advantages of the invention can be more fully understood from the following detailed description taken in conjunction with the accompanying drawings, in which:

FIG. 1 is a block diagram of a conventional broadcasting room control system;

FIG. 2 is a block diagram of a system according to the present invention;

FIG. 3 illustrates a configuration of the system according to the present invention;

FIG. 4 shows an image displayed on a PDA when a broadcasting system control program according to the present invention is executed;

FIG. 5 shows an image displayed on the PDA when an icon A/V MATRIX of FIG. 4 is clicked;

FIG. 6 shows an image displayed on the PDA when an icon A/V MIXER of FIG. 4 is clicked;

FIG. 7 shows an image displayed on the PDA when an icon REMOCON of FIG. 4 is clicked;

FIG. 8 shows an image displayed on the PDA when an icon POWER of FIG. 4 is clicked;

FIG. 9 shows an image displayed on the PDA when an icon SPEAKER of FIG. 4 is clicked; and

FIG. 10 shows an image displayed on the PDA when an icon CAMERA of FIG. 4 is clicked.

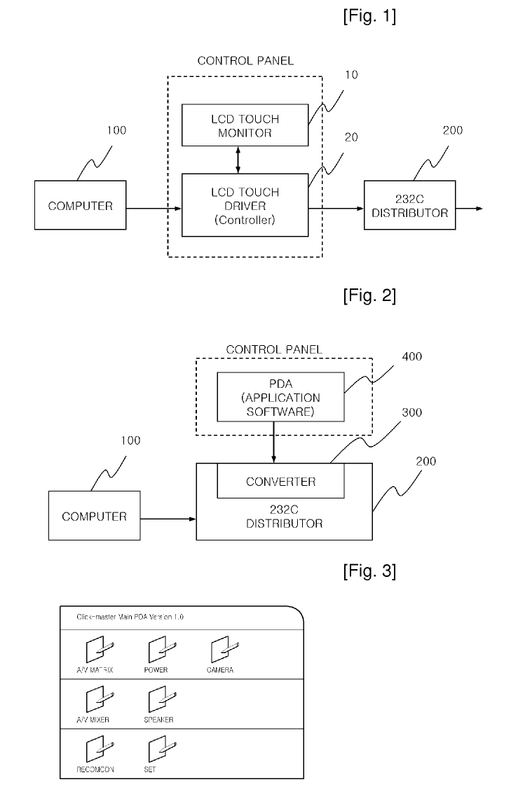

### BEST MODE FOR CARRYING OUT THE INVENTION

The present invention will now be described in detail in connection with preferred embodiments with reference to the accompanying drawings.

FIG. 2 is a block diagram of a system according to the present invention. The system for controlling a broadcasting system or various control systems according to the present invention includes a computer 100 and a PDA 400 in which a program for controlling the broadcasting system is installed, and a 232C (or 1304, USB or the like) distributor 200 for receiving control signals of the computer and the PDA and transmitting the control signals to apparatuses of the broadcasting system. The 232C (or 1394, USB or the like) distributor 200 includes a signal converter 300 for converting a radio signal transmitted from the PDA 400 into an RS 232 (or 1394, USB or the like) signal.

Preferably, the computer and the 232C (or 1394, USB or the like) distributor are connected to each other by wire and the PDA and the 232C (or 1394, USB or the like) are connected to each other wirelessly.

The 232C (or 1394, USB or the like) distributor receives control signals transmitted from the computer and transmits the received control signals to the apparatuses of the broadcasting system to control the broadcasting system. When the computer has a trouble or a user wants to control the broadcasting system from a place other than a broadcasting room, the program installed in the PDA is executed to transmit control signals to the 232C (or 1394, USB or the like) distributor wirelessly. The 232C (or 1394, USB or the like) distributor receives the control signals transmitted from the PDA and converts the control signals into signals for controlling the apparatuses of the broadcasting system to control the apparatuses.

The PDA can use an infrared port, Bluetooth, wireless LAN and the like as a wireless transceiver.

A method of transmitting and receiving signals wirelessly can be easily understood by those skilled in the art so that explanation thereof is omitted.

FIG. 3 illustrates a configuration of the system according to the present invention.

Control signals are transmitted using the PDA 400 in which the program for controlling the broadcasting system is installed and a Bluetooth 401 (or a wireless LAN 402 or an infrared port 403). The control signals are received by the signal converter 220 of the 232C (or 1394, USB or the like) distributor 200 and pass through a signal processing circuit 230 to be transmitted to a micro-controller 240. The micro-controller 240 processes priority of the control signals using a control command and transmits the control signals to RS 232C (or 1394, USB or the like) drivers 250, 251, 252, 253 and 254 to respectively control a main controller 260, a power controller 261, a speaker controller 262, a remote controller 263, a fantilt controller 264.

It is preferable that the computer and the 232C (or 1394, USB or the like) distributor be connected to each other by wire and the PDA and the 232C (or 1394, USB or the like) distributor be connected to each other wirelessly, as described above with reference to FIG. 2. That is, the PDA 400 and the 232C (or 1394, USB or the like) distributor 200 are connected to each other wirelessly in order to control the broadcasting system outside the broadcasting room or control room.

A broadcasting system constructed in such a manner that the 232C (or 1394, USB or the like) distributor 200 receives control signals from the computer 100 is disclosed in Korean Patent No. 418695, applied by the Applicant. That is, a program for controlling apparatuses of the broadcasting system is installed in the computer 100. An RS232C (or 1394, USB or the like) driver 210 of the 232C (or 1394, USB or the like) distributor 200 receives the control signals from the computer 100 and transmits the control signals to the micro-controller 340 via the signal processing circuit 230 that determines priority of the control signals in response to a control command. The micro-controller 240 converts the control signals to signals for controlling the apparatuses of the broadcasting system and transmits the control signals to the RS232C (or 1394, USB or the like) drivers 250, 251, 252, 253 and 254 to control the apparatuses of the broadcasting system.

This construction is used for a wired broadcasting control system. A wireless broadcasting control system will now be explained.

The PDA 400 includes the program (application) for controlling the broadcasting system, installed therein. Control signals of the PDA 400 are wirelessly transmitted to the signal converter 220 of the 232C (or 1394, USB or the like) distributor 200 using the Bluetooth 401, wireless LAN 402 or infrared port 403. The signal converter converts a radio signal into an RS232C (or 1394, USB or the like) signal.

The signals output from the signal converter 220 are input to the signal processing circuit 230 that determines priority of the signals. The signals output from the signal processing circuit are transmitted to the micro-controller 240. The micro-controller processes the priority of the signals in response to a control command and transmits the signals to the RS232C (or 1394, USB or the like) drivers 250, 251, 252, 253 and 254.

The number of the RS232C (or 1394, USB or the like) drivers 250, 251, 252, 253 and 254 corresponds to the number of controllers.

The functions of the controllers controlled by the signals output from the RS232C (or 1394, USB or the like) drivers of the 232C (or 1394, USB or the like) distributor will now be explained.

The main controller 260 executes a function of turning on/off an output port, a function of selecting an input source, a function of controlling a volume and an audio mixer function. The power controller 261 turns on/off power of apparatuses of the broadcasting room, system power, and power for controlling an electromotive background screen.

The speaker controller 262 turns on/off an individual speaker, a group of speaker or all of speakers of a corresponding channel. The remote controller 263 controls an audio apparatus and a video apparatus. The fantilt controller 264 controls a fantilting operation of moving an image of a camera in horizontal and vertical directions, zooming and focusing operations.

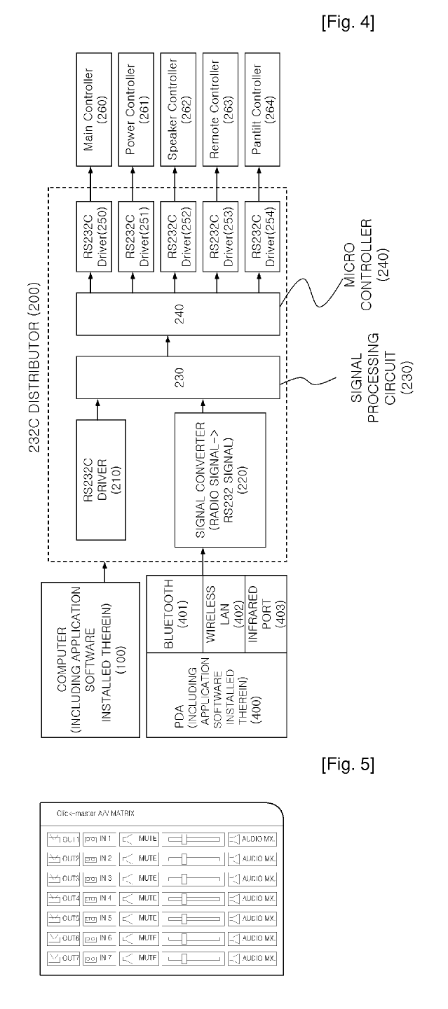

FIGS. 4 through 10 show images displayed on the PDA when the program installed in the PDA is executed.

FIG. 4 shows a main image displayed on the PDA when the broadcasting system control program according to the present invention is executed. When icons displayed on a screen are clicked, the program for controlling the corresponding broadcasting apparatus or other apparatuses is executed.

FIG. 5 shows an image displayed on the PDA when an icon A/V MATRIX of FIG. 4 is clicked. In this case, an output port can be turned on/off and an input source can be selected. In addition, volume control and audio mixer functions are executed. The audio mixer function is executed by selecting audio apparatuses of four channels and microphones of four channels. Accordingly, the A/V MATRIX function performs a multi-broadcasting function because it can select an input source and an audio mixer for each output port.

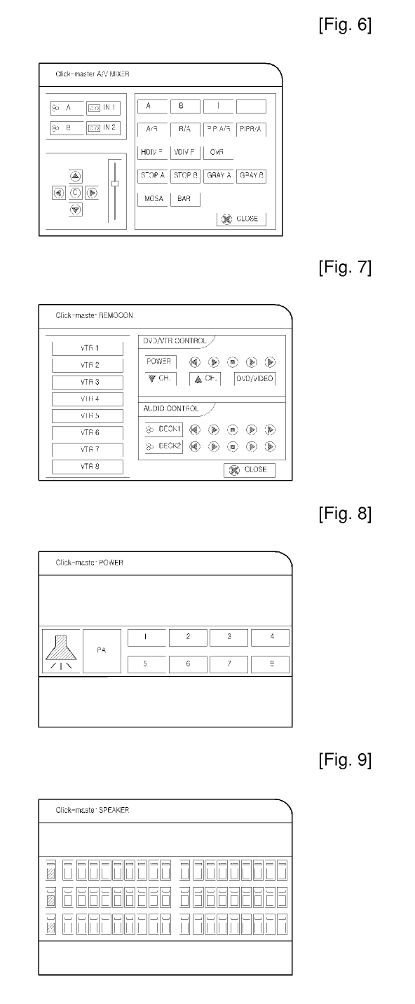

FIG. 6 shows an image displayed on the PDA when an icon A/V MIXER of FIG. 4 is clicked. In this case, two image input sources are selected to execute an image effect function. That is, the two image input sources are selected to selectively perform image division, picture in picture (PIP), mosaic, still image, black-and-white picture and overlay functions.

FIG. 7 shows an image displayed on the PDA when an icon REMOCON of FIG. 4 is clicked. In this case, an A/V apparatus is connected to the remote controller to transmit a control command of each apparatus. The A/V apparatus can be set by setting an environment in FIG. 4.

FIG. 8 shows an image displayed on the PDA when an icon POWER of FIG. 4 is clicked. In this case, various apparatuses, system power and an electromotive background screen in the broadcasting room are connected to the power controller to transmit control commands. The various apparatuses, system power and electromotive background screen can be set by setting an environment in FIG. 4.

FIG. 9 shows an image displayed on the PDA when an icon SPEAKER of FIG. 4 is clicked. In this case, a control command is transmitted through the speaker controller to an individual speaker, a group of speakers or all of speakers of a corresponding channel. A channel used can be set by setting an environment in FIG. 4 in response to the number of speaker controllers used.

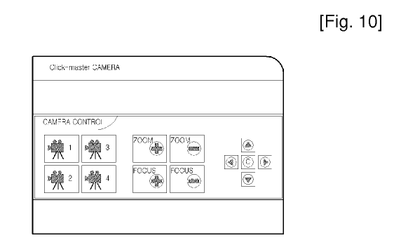

FIG. 10 shows an image displayed on the PDA when an icon CAMERA of FIG. 4 is clicked. In this case, a remote control command for camera zooming and focusing is executed through the fantilt controller.

### INDUSTRIAL APPLICABILITY

According to the present invention, a broadcasting system in a broadcasting room can be controlled not only in the broadcasting room but also outside the broadcasting room using a PDA in which a program of controlling a broadcasting control system or other electronic apparatuses.

An output ports, sound elimination, volume control, an audio mixer, an A/V mixer, A/V apparatuses, system power, lighting, a speaker controller, fantilt of a camera, VTR/deck/DVD combo (or video apparatus or audio apparatus) and so on can be controlled outside the broadcasting room by clicking corresponding icons of the PDA.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A system for remotely controlling a broadcasting apparatus using a PDA comprising:
a PDA in which a program of controlling a broadcasting system is installed;
a wireless transmitter for wirelessly transmitting control signals according to the execution of the program installed in the PDA; and
a distributor for receiving the control signals from the wireless transmitter to control the broadcasting apparatus,
whereby the broadcasting apparatuses are controlled by the control signals output from the distributor.

2. The system for remotely controlling a broadcasting apparatus using a PDA as claimed in claim 1, wherein the distributor is selected by at least what one among 232c, 1394, USB.

3. A system for remotely controlling a broadcasting apparatus using a PDA, wherein control signals of a PDA in which a program of controlling a broadcasting system is installed are transmitted wirelessly, a signal converter of a 232C distributor receives the control signals, the control signals received by the 232C distributor are input to a signal processing circuit that determines priority of the control signals, the signals input to the signal processing circuit are transmitted to a micro-controller for performing a control command, the priority of the control signals is processed by the control command of the micro-controller and input to RS232C drivers to control a main controller, a power controller, a speaker controller, a remote controller and fantilt controller.

4. The system for remotely controlling a broadcasting apparatus using a PDA as claimed in claim 3, wherein the main controller carries out a function of turning on/off an output port, a function of selecting an input source (A/V MATRIX function), a function of controlling a volume and an audio mixer function.

5. The system for remotely controlling a broadcasting apparatus using a PDA as claimed in claim 3, wherein the power controller controls power of apparatuses of the broadcasting room, system power, and power of an electromotive background screen.

6. The system for remotely controlling a broadcasting apparatus using a PDA as claimed in claim 3, wherein the speaker controller turns on/off an individual speaker, a group of speaker or all of speakers of a corresponding channel.

7. The system for remotely controlling a broadcasting apparatus using a PDA as claimed in claim 3, wherein the remote controller controls an A/V apparatus.

8. The system for remotely controlling a broadcasting apparatus using a PDA as claimed in claim 2, wherein the fantilt controller controls a fantilting operation of moving an image of a camera in horizontal and vertical directions and zooming and focusing operations.
